(19) United States
(12) Patent Application Publication
(10) Pub. No.: US 2017/0171085 A1
(43) Pub. Date: Jun. 15, 2017

(54) Traffic Engineering System and Method for a Communications Network

(71) Applicant: Xu LI, Nepean (CA)

(72) Inventor: Xu LI, Nepean (CA)

(73) Assignee: Huawei Technologies Co., Ltd., Shenzhen (CN)

(21) Appl. No.: 14/969,024

(22) Filed: Dec. 15, 2015

(51) Int. Cl. H04L 12/803; H04L 12/707; H04L 12/911; H04L 12/26

(52) U.S. Cl. CPC H04L 47/125; H04L 43/0894; H04L 45/24; H04L 47/822; H04L 47/781

(57) ABSTRACT

An aspect of the disclosure provides a method for transmitting a plurality of packets between nodes of a communications network. The method includes receiving at a traffic engineering (TE) entity, one or more network traffic parameters from the nodes. The method further includes the TE entity providing instructions for routing at least a subset of the plurality of packets using one or more routes determined by the TE entity based on the one or more network traffic parameters. In some embodiments, the network traffic parameters comprise a packet generation rate in packets per second for packets arriving at a source node. In some embodiments the packet generation rate is received from the source node. In some embodiments the packet generation rate is an estimate of the number of packets per second received at the source node, and the packet generation rate is received from a node other than the source node.

### FIELD OF THE INVENTION

The present invention pertains to the field of network communications, and in particular to a traffic engineering system and method for a communications network.

### BACKGROUND

Network Traffic Engineering (TE) relates to the control and optimization of traffic flow throughout a network in the most efficient and effective manner. A TE component may be used to manage the flow of traffic throughout the network, including the planning of routes for packets or groups of packets, and the allocation of network resources in order to meet desired Quality of Service (QoS) requirements. However, the planning and alteration of routing configurations must be carefully performed in order to preserve efficient network operations. These challenges are further complicated when dealing with Machine Type Communication (MTC) traffic, which generates significantly more packets than other traffic types. In these cases, the processing ability of individual network routers may become the limiting factor in system performance, rather than bandwidth or other network resources. Accordingly, there is a need for a traffic engineering system and method that can address one or more of the above limitations, including the effective handling of large volumes of MTC traffic.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide an improved traffic engineering system and method. In certain embodiments, the traffic engineering system is capable of performing traffic, routing and allocation for MTC traffic.

An aspect of the disclosure provides a method for transmitting a plurality of packets. The method includes obtaining a packet generation rate in packets per second fix packets arriving at a source node. The method also includes obtaining node status indicating packet processing capacity. The method also includes sending instructions for transmitting packets between nodes, wherein the instructions are dependent on the packet generation rate in packets per second and on the node status. In some embodiments, the node status indicates the packet processing capacity of nodes (or a subset of nodes) in a communication network capable of transmitting packets from a source node to a destination node. In some embodiments the method is performed by a traffic engineering (TE) entity in the network. In some embodiments the attribute of the packet generation rate can be received directly by the TE entity, whereas in other embodiments the TE entity received network traffic parameters and then generates (e.g., calculates) the attribute based on those parameters. Accordingly, in some embodiments obtaining the packet generation rate in packets per second includes receiving, by the TE entity, the packet generation rate in packets per second from any one of a source node, a network customer, and a network node other than the source node. In some embodiments the TE entity obtains the packet generation rate in packets per second by receiving, by the TE entity, a network traffic parameter; and generating, by the TE entity, the packet generation rate in packets per second based on the network traffic parameter. In some embodiments obtaining node status indicating packet processing capacity includes receiving, by the TE entity, the node status indicating packet processing capacity from any one of all nodes, a subset of nodes, and a node monitor. In some embodiments obtaining node status indicating packet processing capacity includes receiving, by the TE entity, network node parameters including from any one of all nodes, a subset of nodes and a node monitor; and generating, by then entity, the node status based on the received network node parameters. In some embodiments the network node parameters are selected from the list including packet arrival rate, packet processing capacity, packet input queue length, and packet waiting time. In some embodiments sending an instruction for transmitting packets between nodes includes any one of the following: sending, by the TE entity, an instruction for updating routing table saved in nodes; sending, by the TE entity, an instruction for aggregating multiple packets into one packet; and sending, by the TE entity, an instruction for modifying one or more packet header identifiers. In some embodiments the instruction includes traffic splitting information for multi-path routing of packets based on packets per second. In some embodiments the TE entity providing instructions for transmitting packets includes the TE entity performing an optimization calculation based on an objective function and constraints based on the packet generation rate and the node status to determine the routing instructions.

Another aspect of the disclosure provides a Traffic Engineering (TE) entity. The TE entity includes a processor configured to obtain a packet generation rate in packets per second for packets arriving at a source node and node status indicating packet processing capacity. The entity further includes a transmitter communicatively coupled to the processor for transmitting routing instructions to the nodes for transmitting packets, wherein the routing instructions are dependent on the packet generation rate in packets per second and on the node status. Some embodiments further include a receiver coupled to the processor. In some embodiments the receiver is configured to receive the packet generation rate in packets per second received from any one of a source node, a network customer, and a network node other than the source node. In some embodiments the receiver is configured to receive a network traffic parameter and the processor is configured to generate the packet generation rate in packets per second based on the network traffic parameter. In some embodiments the receiver is configured to receive the node status indicating packet processing capacity from any one of: all nodes, a subset of nodes, and a node monitor. In some embodiments the network node parameters are selected from the list consisting of packet arrival rate, packet processing capacity, packet input queue length, and packet waiting time. In some embodiments the the processor is further configured to determine one or more routes according to the packet generation rate and the node status and the transmitter is configured to transmit instructions for routing the plurality of packets along the one or more determined routes.

Another aspect of the disclosure provides a device for transmitting a plurality of packets. The device includes a processor, and an input interface communicatively coupled to the processor. The input interface receives parameters related to a packet generation rate in packets per second for packets arriving at a source node, and parameters related to node status indicating packet processing capacity of nodes in a network. The device further includes a memory communicatively coupled to the processor and having stored thereon machine readable code which when executed by the processor causes the processor to determine routing instructions for routing a plurality of packets between the nodes of a communications network according to the parameters. The device further includes an output interface communicatively coupled to the processor for outputting the routing instructions. In some embodiments the machine readable code includes machine readable code for performing an optimization calculation based on an objective function and constraints based on the packet generation rate and the node status. In some embodiments the machine readable code includes machine readable code for determining the packet generation rate in packets per second for packets arriving at a source node from the received parameters; and the node status of nodes along possible paths from the source node to a destination node from the received parameters. In some embodiments the input interface receives directly the packet generation rate from a source node for packets directed to a destination node, and/or the node status from nodes along possible paths from the source node to the destination node.

Another aspect of the disclosure provides a method for transmitting a plurality of packets between nodes of a communications network. The method includes receiving, at a traffic engineering (TE) entity, one or more network traffic parameters from the nodes. The method further includes the TE entity providing instructions for routing at least a subset of the plurality of packets using one or more routes determined by the TE entity based on the one or more network traffic parameters. In some embodiments, the network traffic parameters comprise a packet generation rate in packets per second for packets arriving at a source node. In some embodiments the packet generation rate is received from the source node. In some embodiments the packet generation rate is an estimate of the number of packets per second received at the source node, and the packet generation rate is received from a node other than the source node. In some embodiments the source node receives many packets from a plurality of devices which all belong to a network customer and wherein the packet generation rate is received from the network customer. In some embodiments the parameters can be general for all types of traffic; or can be specified for particular types of traffic. In some embodiments receiving, at a TE entity, one or more network traffic parameters further comprises receiving node parameters from one or more nodes of the communications network capable of routing packets from the source node to a destination node. In some embodiments the IT entity providing instructions for routing comprises transmitting forwarding rules to the nodes, the forwarding rules including a packet allocation in packets per second. In some embodiments the forwarding rules further include routing information. In some embodiments the TE entity providing instructions for routing comprises the TE entity performing an optimization calculation based on an objective function and constraints based on the network traffic parameters to determine the routing instructions. In some embodiments the node parameters are selected from the list comprising packet arrival rate, packet processing capacity, packet queue length, and packet waiting time. In some embodiments the instructions are provided to the nodes of the communications network. In some embodiments the method further includes receiving at a source node a plurality of packets which share a characteristic and the TE entity receives a packet generation rate for packets which share the characteristic, and the TE node providing instructions for routing at least a subset of the plurality of packets using a route determined by the TE, entity based on the one or more network traffic parameters and the characteristic. In some embodiments the characteristic comprises a common service or a common destination.

Another aspect of the disclosure provides Traffic Engineering (TE) entity. The TE entity includes a processor; an input interface communicatively coupled to the processor, for receiving one or more network traffic parameter nodes of a communications network; a memory communicatively coupled to the processor and having stored thereon machine readable code which when executed by the processor causes the processor to determine instructions for transmitting a plurality of packets between the nodes of a communications network according to the one or more network traffic parameters; and an output interface communicatively coupled to the processor for transmitting the instructions to the nodes. In some embodiments the network traffic parameters comprise a packet generation rate measured in packets per second. In some embodiments the network traffic parameters comprise node parameters received from the nodes of the communications network. In some embodiments the node parameters are selected from the list consisting of packet arrival rate, packet processing capacity, packet queue length, and packet waiting time. In some embodiments the interface receives the packet generation rate from a source node for packets directed to a destination node. In some embodiments the interface receives the node parameters from nodes along possible paths from the source node to the destination node. In some embodiments the instructions for transmitting the plurality of packets between nodes of the communication network comprises determining one or more routes according to the one or more network traffic parameters, and routing the plurality of packets along the one or more determined routes. In some embodiments the instructions for transmitting the plurality of packets between nodes of the communications network comprises performing an optimization calculation based on an objective function and constraints based on the network traffic parameters to determine the routing and packet allocation. In some embodiments the packet allocation is measured in packets per second.

### BRIEF DESCRIPTION OF THE FIGURES

Further features and advantages of the present invention will become apparent from the following detailed description, taken in combination with the appended drawings, in which:

FIG. 1 is a schematic diagram of a communications system including a traffic engineering entity communicatively coupled to a wireless communications network, according to an embodiment;

FIG. 2 is a flow chart illustrating a method for transmitting packets in a communications network, according to an embodiment;

FIG. 3 is a flow chart illustrating a method of obtaining a packet generation rate in packets per second for packets arriving at a source node according to an embodiment;

FIG. 4 is a flow chart illustrating a method for obtaining node status indicating packet processing capacity of the nodes, according to another embodiment;

FIG. 5 is a schematic diagram of a communications system including a traffic engineering node communicatively coupled to a wireless communications network and a network monitoring module, according to an embodiment;

FIG. 6 is a schematic diagram of a traffic engineering node, according to another embodiment.

It will be noted that throughout the appended drawings, like features are identified by like reference numerals.

### DETAILED DESCRIPTION

Traffic Engineering (TE) systems and methods are traditionally focused on traffic flow for internet and ISP-based infrastructures. Accordingly, current TE solutions may fail to consider specific issues related to wireless networks which provide communication to large numbers of Machine Type Communications (MTC) devices. MTC generally involves communication between a centralized core network and a large number of devices, such as smart meters, security systems, navigation systems, health systems, and so forth. Such networks may have a very large number of devices each capable of transmitting and receiving data packets between wireless access points and a core network.

One issue that merits consideration is the limited processing ability of individual nodes (e.g. routers, access points, base stations, servers, eNBs, etc.) of the network, which results in unwanted delays or lags in traffic. Accordingly, the efficient management of traffic and allocation of resources in a network which carries large volumes of packets, which can include MTC packets, is a challenging task.

Embodiments of the present invention are directed towards a TE entity and method capable of at least partially addressing one or more of the above issues.

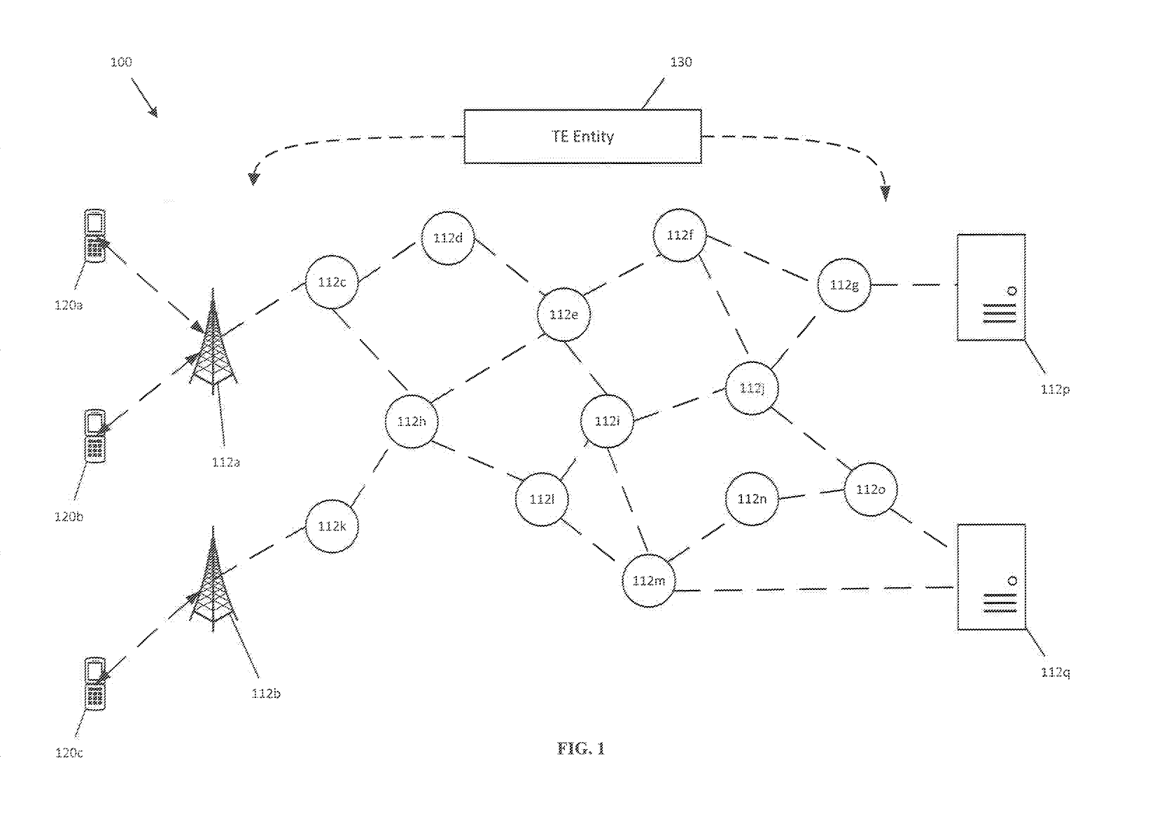

Referring to FIG. 1, there is shown an embodiment of a communications system 100. The communications system 100 includes a TE entity 130 communicatively coupled to a communications network 112. The TE entity 130 can be a dedicated TE node, or it can include a TE function instantiated on a node in the network which also provides other functions. It should be noted that, in some embodiments, the TE entity 130 can include a Software Defined Networking (SDN) controller. Alternatively, the TE entity can co-operate with an SDN controller (not shown)As a further alternative, an SDN controller can include the TE functionality. The communications network 112 includes a plurality of inter-coupled nodes 112a-112q, including Access Points (APs) 112a-112b, routers 112c-112o, and destination (or end) nodes 112p-112q. Destination nodes 112p-112q can be servers or gateway nodes which act as gateways to other networks. They are called end or destination nodes in this specification as they represent a destination or sink for packets as far as the TE entity 130 is concerned. APs 112a-112b can be considered source nodes, as they represent entry points for packets which need to traverse the network. Nodes 112a-112q may be inter-coupled, for example via wired link, wireless link, or a combination thereof. In certain embodiments, nodes 112a-112b of communications network 112 may form a radio access network (RAN), and nodes 112c-112o may form a core network.

Wireless devices 120a-120c are wirelessly coupled to APs 112a-112b for transmitting and receiving packets, such as MTC packets, between servers 112p-112q via routers 112c-112o. The packets may travel along one or more routes established between APs 112a-112b and servers 112p-112q. For example, packets between wireless device 120a and server 112p may travel along a first route (112a, 112c, 112d, 112e, 112f, 112, 112g, 112p), a second route (112a, 112c, 112d, 112e, 112f, 112j, 112g, 112p), a third route (112a, 112c, 112h, 112e, 112i, 112j, 112g, 112p), and so forth. Similarly, packets between wireless device 120c and server 112q may travel along a fourth route (112b, 112k, 112h, 112l, 112i, 112m, 112n, 112o), a fifth route (112h, 112k, 112h, 112e, 112i, 112m, 112n, 112o, 112q) and so forth. Although only five routes are detailed above, additional routes may be established between APs 112a-112b and end nodes 112p-112q. In other embodiments comprising different network topologies (not shown), a plurality of routes may be established between various APs, routers, and servers for transmitting packets between various wireless devices and end points.

Nodes 112a-112q may each include a routing table (not shown), used for determining the subsequent destination of an incoming packet. For example, packets may include a packet header including identifiers such as packet ID, path ID, or link ID. Upon receiving an incoming packet, nodes 112a-112q will compare the identifiers (such as packet ID or path ID) with the routing table, and forward the packet to the appropriate destination node according to the routing table. In this way, the routing table directs each packet or group of packets to the “next stop” along a predetermined route for each packet or group of packets. In some embodiments, nodes 112a-112q may alternatively refer to a centralized routing table (not shown) in order to determine the subsequent destination node for each incoming packet or group of packets.

The TE entity 130 is communicatively coupled to one or more nodes 112a-112q of communications network 112 for making and implementing traffic engineering decisions concerning the transmission of packets, for example between wireless devices 120a-120c and end nodes 112p-112q. This may include route selection for determining the paths along which packets are transmitted (for example, the first route, the second route, etc.) and packet allocation. In some embodiments, the TE 130 determines how to populate the routing tables at routers and thus impacts the routers' forwarding behavior. The action of populating these routing tables may be taken by an SDN controller, which may or may not necessarily be the same controller that is running the TE entity.

In operation, the TE entity 130 receives one or more network traffic parameters, for example from one or more nodes 112a-112q of communications network 112 or a network monitoring module (not shown). The network traffic parameters may include network topology information of communications network 112, a packet generation rate (measured in packets per second) from a network monitoring module (not shown) or from one or more nodes 112a-112q, or one or more node parameters from individual nodes 112a-112q, such as packet arrival rate, packet processing capacity, packet queue length, and packet waiting time. Based on the received network traffic parameters, TE entity 130 determines appropriate traffic engineering decisions. The traffic engineering decisions may then be used to provide instructions for executing transmission of packets between nodes 112a-112q, including packet routing and allocation. For example, instructions may be sent to one or more of nodes 112a-112q for updating internal routing tables saved within the nodes in order to forward specific packets or groups along certain routes according to the traffic engineering decision. In some embodiments, the instructions may also control packet aggregation for aggregating multiple packets into a single packet to increase transmission efficiency. In embodiments including a centralized routing table, the instructions may be used to update the centralized routing table to inform nodes 112a-112q as to where to subsequently forward incoming packets. Alternatively, the instructions may be used for modifying packet header identifiers (such as the path ID or link ID for path based or link based routing) so that particular packets may be “re-routed” or “re-directed” to travel along different routes as determined according to the traffic engineering decision. For example, source-based transport mechanisms may carry a list of next-hop addresses in a header, which may be a packet header, or another header, for example an MPLS header. The instructions may include sending forwarding information base (FIB) table updates to the nodes. Further the instructions sent by the TE entity can include traffic splitting information for multi-path routing of packets based on packets per second. Further example information can be found in U.S. Ser. No. 14/643,883 filed Mar. 10, 2015 with title Traffic Engineering Feeder for Packet Switched Networks, which is hereby incorporated by reference in its entirety.

In some embodiments, one of the traffic engineering decisions made by the TE 130 relates to packet allocation. Packet allocation refers to determining a rate of packets to be transmitted over a path or a link (for example, a number of packets per second). Packet allocation differs from traditional TE outputs, which typically output a “rate allocation” over a path or a link, which implies number of bits per second, instead of packets per second.

Depending on the embodiment, routing and packet allocation can be decided jointly or separately, depending on the optimization approach taken. Also, the TE decisions can be made per flow or per group of flows. In the latter case, a group of flows can be considered an aggregate flow.

In some embodiments, the TE entity 130 (and/or an associated SDN controller that is responsible for populating the routing table) can output forwarding rules, which can include packet allocation decisions together with routing decisions. For example, a forwarding rule may instruct a router, upon receiving packets with flow ID F200, to send 20% of the packets over a first computed path, 30% over a second path, and 50% over a third path. In this example, each path is assigned a path ID based on a forwarding rule.

In another example involving a link ID based forwarding rule, a router will forward the packets toward the specified incidental links according to an associated packet allocation.

Packet allocation can be represented as a percentage as the flow's packet generation rate is known (and is one of the node parameters sent to the TE entity 130 as discussed above).

An aspect of the disclosure discusses methods and systems for avoiding overloading routers. A router can be overloaded if it receives more incoming packets than it can process. Accordingly, an aspect of the TE optimization computes packet allocation such that the number of incoming packets to each router is balanced, to avoid overloading any of the routers. In other words, embodiments provide a packet allocation to balance the load on the routers and, to the extent possible paths exist, to allocate more packets to routers with excess capacity. However, alternative measures should be implemented to throttle the rate of incoming packets if all routers are congested.

An example will now be discussed. In this example, assume a large number of MTC packets arrive at AP 112a which have a common characteristic, for example a common service or destination. As an example, a large number of smart meters may be transmitting meter readings to a utility company via a common service provided by the network operator to the utility company. Assume these packets all have a common destination 112q, which may be a gateway to the utility company's internal network. Referring to FIG. 1, the shortest route (in terms of number of links) from 112a to 112q is via nodes 112c-112h-112l-112m. However, some nodes may be overloaded, making an alternative route more desirable from a network congestion standpoint. For example, node 112h may be overloaded as it can also receive large numbers of packets from AP 112b via node 112k Accordingly, while longer, the TE entity 130 can compute an alternative route: 112a-112c-112d-112e-112i-112j-112o-112q. The TE entity 130 can also compute a packet allocation for the routers, to allocate a percentage of packets per path and balance the load on each of the routers.

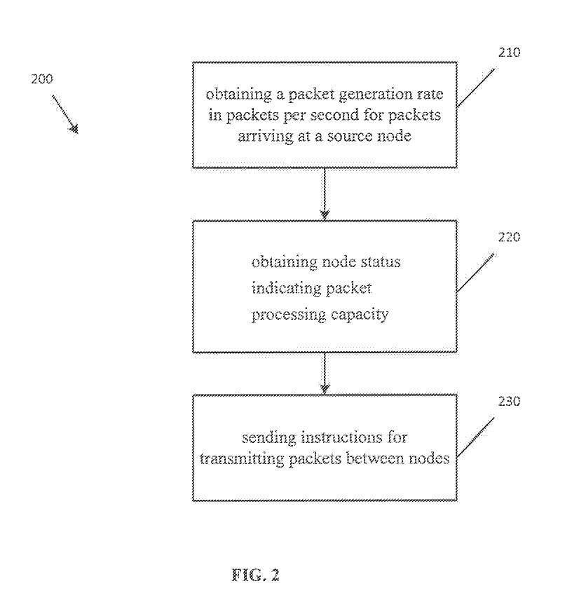

Referring to FIG. 2, there is shown a flow chart 200 illustrating a method for transmitting a plurality of packets, for example through TE entity 130 in communications system 100 of FIG. 1, according to an embodiment. At step 210, the method includes obtaining a packet generation rate in packets per second for packets arriving at a source node. For example, step 210 can include receiving, by the TE entity, the packet generation rate in packets per second from any one of a source node, a network customer, and a network node other than the source node. This packet generation rate may be for all packets or for a subset of packets with a characteristic, such as belonging to a common service having a common destination, for example MTC packets from smart meters directed to a utility company. This packet generation rate may be received from the source node or from a network monitoring module (not shown). The packet generation rate can be an estimate of the number of packets per second received at the source node and the packet generation rate can be received from a node other than the source node. For example, the source node can receive many packets from a plurality of devices which all belong to a network customer and the packet generation rate can be an estimated receipt from that network customer.

At step 220, the method includes obtaining node status indicating packet processing capacity of the nodes. It should be appreciated that the TE entity may receive parameters from all of the nodes the nodes of the communications network, or a subset. For example, the TE entity 130 may receive node parameters from one or more nodes of the communications network capable of routing packets from the source node to a destination node. In some embodiments, the TE entity 130 receives node parameters from a subset of these nodes, far example nodes congested nodes. Accordingly, in some embodiments, this step includes receiving, by the TE entity, the node status indicating packet processing capacity from any one of all nodes, a subset of nodes, and a node monitor.

At step 230 the method includes sending instructions for transmitting packets between nodes. These instructions are generated by the TE entity, and are dependent on the packet generation rate in packets per second and on the node status.

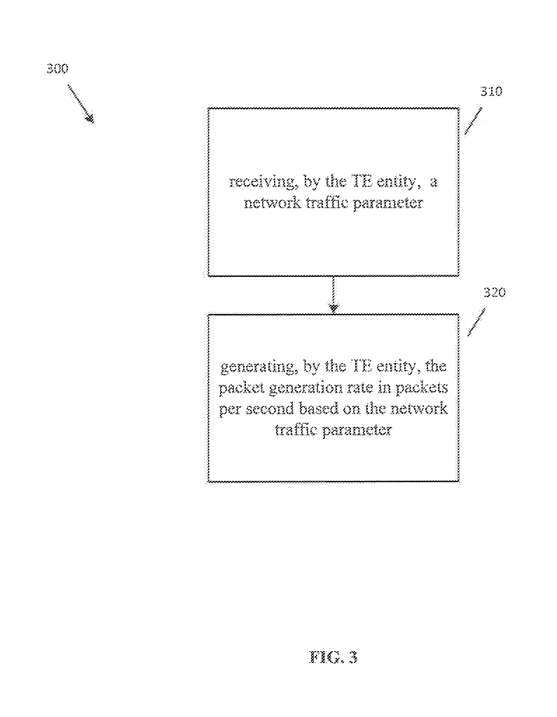

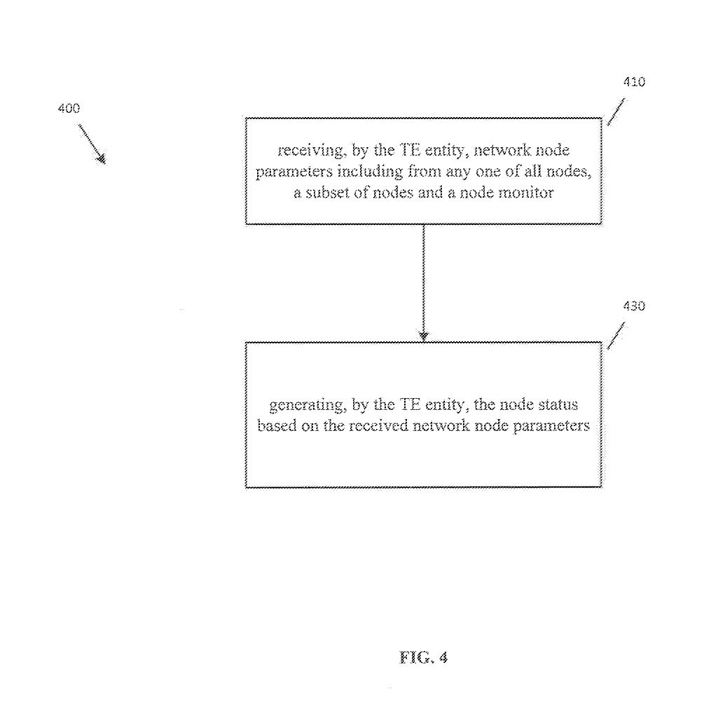

Examples of how these instructions are generated are discussed below. Before that, it is note that in this specification the term obtaining includes directly receiving the attribute, as well as receiving parameters from the nodes, and then generating the attribute from the parameters. Accordingly, FIGS. 3 and 4 illustrate other methods of obtaining the attributes of steps 210 and 220 respectively, according to some embodiments.

As stated, at step 210, the method includes obtaining a packet generation rate in packets per second for packets arriving at a source node. The attribute of the packet generation rate can be received directly by the TE entity. Alternatively, the TE entity obtains this attribute by receiving the parameters from which it can be calculated, and then generates the attribute. Referring to FIG. 3, there is shown a flow chart 300 illustrating a method of obtaining a packet generation rate in packets per second for packets arriving at a source node according to an embodiment. At step 310, one or more network traffic parameters are received by the TE entity. This can include, for example, receiving source rate in bit per second and packet size from the source nodes, a network customer, and a network node other than the source node. Alternatively, this can include receiving source rate in bit per second and a TE configuration parameter of average packet size from the source nodes, a network customer, and a network node other than the source node. At step 320, the traffic engineering entity generates the packet generation rate in packets per second based on received the network traffic parameter.

At step 220, the method includes obtaining node status indicating packet processing capacity of the nodes. Similar to the discussion above with respect to FIG. 3, the attribute of the node status can be received directly by the TE entity. Alternatively, the TE entity obtains this attribute by receiving the parameters from which it can be calculated, and then generates the attribute. Referring to FIG. 4, there is shown a flow chart 400 illustrating a method for obtaining node status indicating packet processing capacity of the nodes, according to another embodiment. At step 410, one or more network node parameters are received from the nodes (or a subset thereof).

The network traffic parameters may be provided by nodes 112a-112q of communications network 112, or from a network monitoring module (not shown). The network node parameters are selected from a list (i.e, may include one or more of): packet arrival rate, packet processing capacity, packet input queue length, and packet waiting time. At step 430, the traffic engineering entity generates the node status base on the received network node parameters.

As stated instructions are provided for transmitting a plurality of packets between nodes of the communication network 112 dependent on the packet generation rate in packets per second and on the node status. This involves the TE entity making a traffic engineering decision according to the node status and packet generation rate. The traffic engineering decision may include route selection and packet allocation for one or more packets or groups based on such factors as the total packet processing capacity, packet generation rate, queue length, packet waiting time, or a combination thereof for a particular route, or a number of constraints that must be satisfied for each route to meet certain QoS requirements. Then instructions are provided for transmitting one or more packets or groups in the communications network 112 according to the determined traffic engineering decision.

Accordingly, the TE entity 130 receives one or more network traffic parameters and determines a traffic engineering decision for transmitting packets or groups of packets between nodes 112a 412q, such as from wireless devices 120a-120c to servers 112p-112q, in order to improve or optimize transmission efficiency in communications network 112. The traffic engineering decision may then be sent in the form of instructions to nodes 112a-112q for executing transmission of packets accordingly. In some embodiments, the packets themselves may be modified (for example, in the packet headers) to contain the traffic engineering instructions, and the nodes 112a-112q may accordingly route or forward the packets according to the instructions in the packet headers. For example, the instructions may involve changing the path ID or link ID of certain packets, in order to “re-route” them according to the traffic engineering decision. Another example is to include the complete route information in the header, i.e. to implement source routing. For example, the node parameters may include input queue length for nodes 112a-112q of the communications network 112, from which the TE entity 130 may determine a route between nodes 112a-112q having the lowest collective input queue length. Instructions are then generated to control the transmission of packets along the determined route having the lowest collective input queue length to improve system efficiency. Alternatively, the network node parameters may include packet processing time for nodes 112a-112q of the communications network 112, from which the TE entity 130 may determine a route between nodes 112a-112q having the lowest collective packet processing time, and instructions may control the transmission of packets along the determined route having the lowest packet processing time to improve system efficiency. It should be appreciated that some parameters are computed from base parameters. In some embodiments, the nodes compute and provide such node parameters as the input queue length, whereas in other embodiments the nodes provide the base parameters and the TE entity does the computation.

In additional embodiments, as further described below, TE entity 130 may utilize network traffic parameters to gauge the operational state of the communications system 112, or to ensure various operational constraints are met in order to meet certain QoS standards. These parameters may in turn be used to determine traffic engineering decisions, which serve as the basis for instructions used to control transmission of packets between nodes 112a-112q of communications network 112.

In some embodiments the TE entity determines a traffic engineering decision by performing an optimization calculation based on an objective function and constraints based on the network traffic parameters to determine the routing instructions. For example, the objective function value may include the sum of packet waiting times for nodes along a particular route, such that the route with the lowest total packet waiting time may be selected for transmission. Alternatively, the objective function to be satisfied is chosen to meet a desired QoS requirement. Finally, instructions are provided for transmitting one or more packets between nodes of communications network 112 according to the results of the optimization calculation. For example, the optimization calculation may be selected to determine which route includes the highest overall packet processing capacity, or lowest packet generation rate, queue length, or packet waiting time, or a combination thereof, and the instructions may cause the transmission of packets or groups of packets along that particular route in order to improve network efficiency.

In certain embodiments, the TE entity solves an optimization problem according to an optimization objective function and a set of constraints. In one such example, an objective function is to minimize the input queue length (i.e. minimize the overall router processing load) at each node in communications network 112. In one embodiment, the optimization problem solved by the TE entity 130 is to satisfy the following objective function, wherein t is the maximum processing time among all nodes:

Minimize t, subject to the following constraints to meet this objective:

$${\sum }_{a ∈ A : {a}_{src} = n} {x}_{a} = {r}_{n}^{-} , ∀ n ∈ N \qquad ( 1 )$$

where:
A: link set
xₐ: MTC packet allocation on link a
rₙ⁻: outgoing MTC packet rate at node n
N: network nodes
a_{src}: source end of link a
   Constraint (1) ensures a solution with rₙ⁻ equaling the outgoing MTC packet rate at node n.

$${\sum }_{a ∈ A : {a}_{dsl} = n} {x}_{a} = {r}_{n}^{+} , ∀ n ∈ N \qquad ( 2 )$$

where:
rₙ⁺: Incoming MTC packet rate at node a
a_{dst}: destination end of link a
   Constraint (2) ensures a solution rₙ⁺ equaling the incoming MTC packet rate at node n.

rₙ⁻=rₙ⁺, ∀n ∈ N:n ∉ S, n ∈ D (3)

where:
S: sources a sub set of IV
D: destinations, a subset of N
   Constraint (3) ensures that incoming and outgoing MTC packet rates are equal for non-source, non-destination nodes.

rₙ⁻−rₙ⁺=gₙ, ∀n ∈ S (4)

where:
gₙ: MTC packet generation rate at source n
   Constraint (4) ensures that the outgoing MTC packet rate is equal to the incoming MTC packet rate plus the MTC packet generation rate at source nodes.

pₙ(rₙ⁺+gₙ+bₙ)=lₙ, ∀n ∈ N (5)

where:
n: packet processing time at node n
bₙ: background traffic packet arrival rate at node n
lₙ: packet processing (input) queue length
   Constraint (5) computes the input queue length at each node. The input queue refers to the queue built up due to packet header processing. The length of the input queue indicates the number of packets in the queue.

lₙ≦t, ∀n ∈ N (6)

Constraint (6) ensures that, under the minimization objective, t equals or exceeds the maximum input queue length among all nodes.

xₐ≧0, ∀a ∈ A (7)

Constraint (7) ensures no negative packet allocation decision is made over any link in the network.

The above constraints presume that any-casting based MTC application (e.g. meter reading), and the intersection of source node set (8) and destination node set (D) are empty. Any-casting, implies that the traffic is to be delivered to any of a set of given destinations. It is different from uni-casting, in which traffic is routed to a unique destination.

In operation, the TE entity computes constraints 1-7 and then determines the route and packet allocation to minimize the input queue length for each node.

It should be appreciated that, in other embodiments, different objective functions can be optimized, which may include different constraints to achieve particular TE optimization objectives. A skilled person would appreciate that any number of different constraints, formulas, or computations may be used by the TE entity 130 to achieve a desired traffic engineering objective, or meet certain QoS standards.

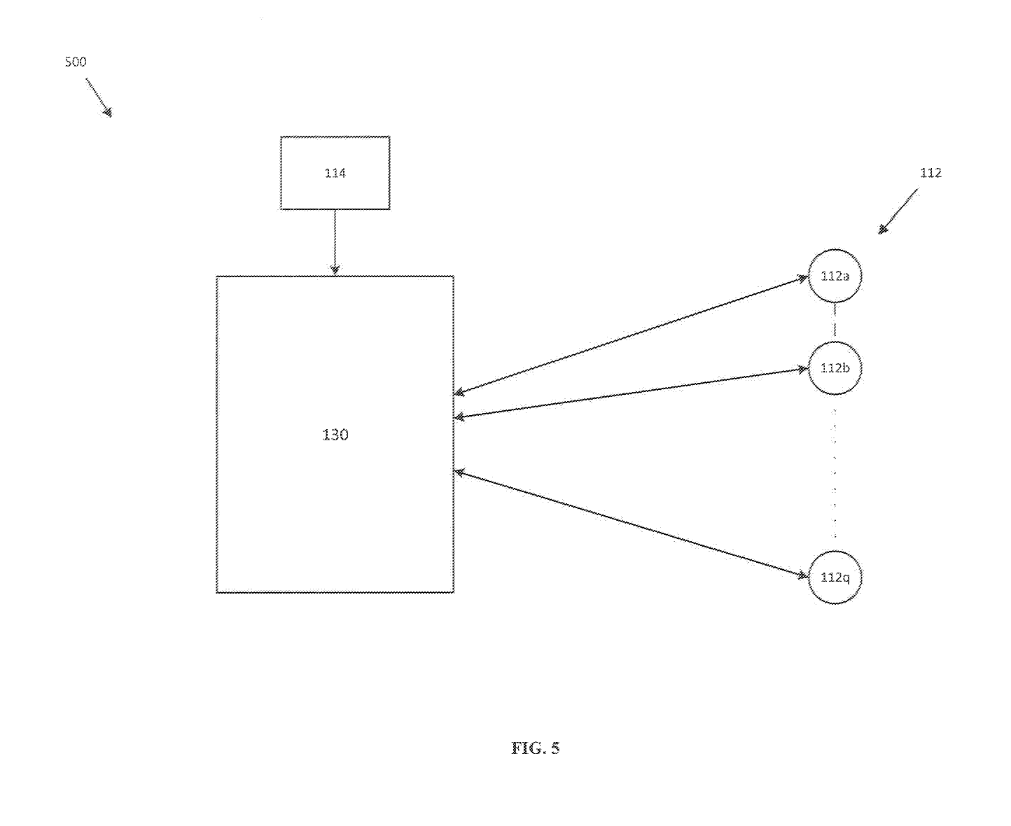

Referring to FIG. 5, there is shown another embodiment of a communications system 500. The communications system 500 includes a TE entity 130 communicatively coupled to a plurality of nodes 112a-112q of communications network 112, and to a network monitoring module 114. Nodes 112a-112q may be inter-coupled, for example via wired link, wireless link, or a combination thereof (not shown). In operation, the TE entity 130 receives packet generation rates (measured in packets per second) from the network monitoring module 114 for one or more of nodes 112a-112q, and node parameters from one or more of nodes 112a-112q. As described above, the TE entity 130 then provides instructions for transmitting one or more packets between nodes 112a-112q based on the packet generation rates and the node parameters. In certain embodiments, the TE entity 130 utilizes the packet generation rates and the node parameters to determine routing and packet allocation decisions for transmitting packets or flows of packets between nodes 112a-112q. As stated, in some embodiments, the routing and packet allocation decisions are determined by the TE entity 130 solving an optimization problem according to an optimization objective function and constraints based on the network traffic parameters (which can include the packet generation rate and node parameters), instructions may then be sent to nodes 112a-112q for executing transmission of packets according to the IL decisions, or for modifying the packets (e.g. the path ID or link ID of the packet headers, or the source routing information in the packet headers) to route or “re-route” them according to the traffic engineering decisions.

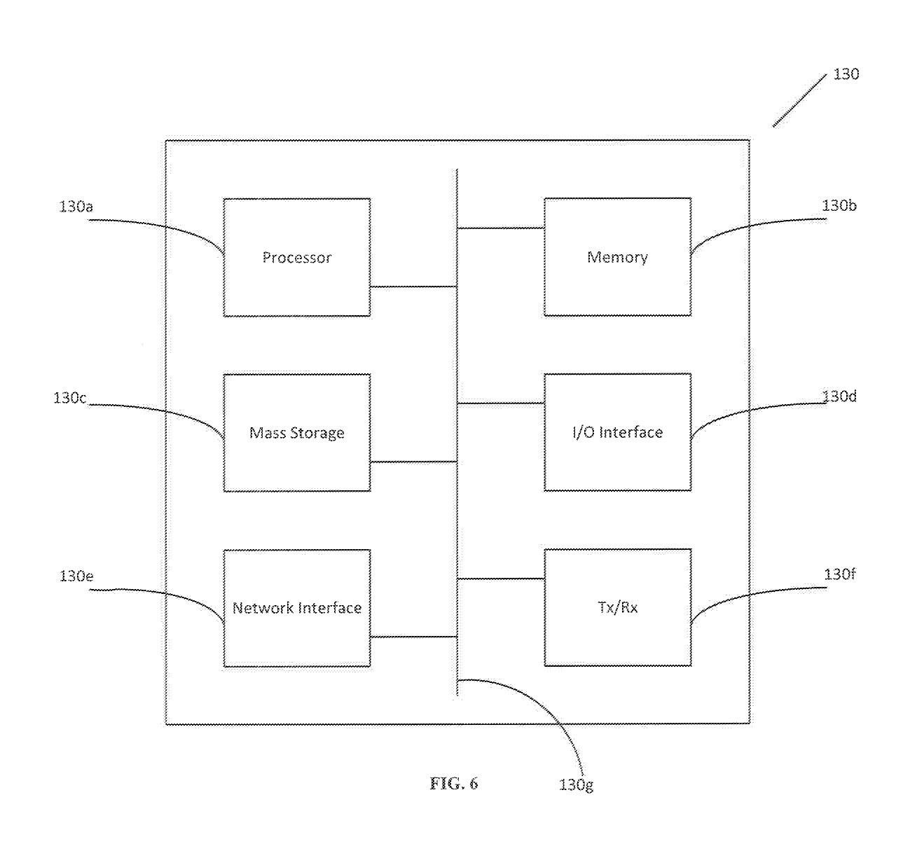

Referring to FIG. 6, there is shown a schematic diagram of TE entity 130 according to an embodiment. As shown, TE entity 130 includes a processor 130a, working memory 130b, non-transitory mass storage 130c, network interface 130d, I/O interface 130e, and transceiver 130f (which includes a receiver (Rx) and a transmitter (Tx), all of which are communicatively coupled via bi-directional bus 130g. According to certain embodiments, any or all of the depicted elements may be utilized, or only a subset of the elements. Further, TE entity 130 may contain multiple instances of certain elements, such as multiple processors, memories, or transceivers. Also, elements of TE entity 130 may be directly coupled to other elements without the bi-directional bus.

The memory 130b may include any type of non-transitory memory such as static random access memory (SRAM), dynamic random access memory (DRAM), synchronous DRAM (SDRAM), read-only memory (ROM), any combination of such, or the like. The mass storage element 130c may include any type of non-transitory storage device, such as a solid state drive, hard disk drive, magnetic disk drive, optical disk drive, USB drive, or any computer program product configured to store data and machine executable program code. According to certain embodiments, the memory 130b or mass storage 130e may have recorded thereon machine readable code executable by the processor 130a for performing the aforementioned functions and steps of TE entity 130.

FIG. 6 also serves to illustrate another embodiment can include a device, which can be incorporated within a TE entity or some other node which can implement the TE entity.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for transmitting a plurality of packets, the method comprising:
obtaining a packet generation rate in packets per second for packets arriving at a source node;
obtaining node status indicating packet processing capacity; and
sending instructions for transmitting packets between nodes;
wherein the instructions are dependent on the packet generation rate in packets per second and on the node status.

2. The method of claim 1 wherein the method is performed by a traffic engineering (TE) entity in the network.

3. The method of claim 2, wherein obtaining the packet generation rate in packets per second comprises:
receiving, by the TE entity, the packet generation rate in packets per second from any one of a source node, a network customer, and a network node other than the source node.

4. The method of claim 2, wherein the TE entity obtains the packet generation rate in packets per second comprises:
receiving, by the TE entity, a network traffic parameter; and
generating, by the TE entity, the packet generation rate in packets per second based on the network traffic parameter.

5. The method of claim 2, wherein obtaining node status indicating packet processing capacity comprises:
receiving, by the TE entity, the node status indicating packet processing capacity from any one of all nodes, a subset of nodes, and a node monitor.

6. The method of claim 2, wherein obtaining node status indicating packet processing capacity comprises:
receiving, by the TE entity, network node parameters including from any one of all nodes, a subset of nodes and a node monitor; and
generating, by the TE entity, the node status based on the received network node parameters.

7. The method of claim 6 wherein the network node parameters are selected from the list comprising packet arrival rate, packet processing capacity, packet input queue length, and packet waiting time.

8. The method of claim 2, wherein sending an instruction for transmitting packets between nodes comprises any one of the following:
sending, by the IT entity, an instruction for updating routing table saved in nodes;
sending, by the IT entity, an instruction for aggregating multiple packets into one packet; and
sending, by the TE entity, an instruction for modifying one or more packet header identifiers.

9. The method of claim 8, wherein the instruction includes traffic splitting information for multi-path routing of packets based on packets per second.

10. The method of claim 2 wherein the TE entity providing instructions for transmitting packets comprises the TE entity performing an optimization calculation based on an objective function and constraints based on the packet generation rate and the node status to determine the routing instructions.

11. A Traffic Engineering (TE) entity comprising:
a processor configured to obtain a packet generation rate in packets per second for packets arriving at a source node and node status indicating packet processing capacity; and
a transmitter communicatively coupled to the processor for transmitting routing instructions to the nodes for transmitting packets;
wherein the routing instructions are dependent on the packet generation rate in packets per second and on the node status.

12. The TE entity of claim 11 further comprising a receiver, configured to receive the packet generation rate in packets per second received from any one of a source node, a network customer, and a network node other than the source node.

13. The TE entity of claim 11 further comprising a receiver configured to receive a network traffic parameter and the processor is configured to generate the packet generation rate in packets per second based on the network traffic parameter.

14. The TE entity of claim 11 wherein further comprising a receiver configured to receive the node status indicating packet processing capacity from any one of: all nodes, a subset of nodes, and a node monitor.

15. The TE entity of claim 11 wherein the network node parameters are selected from the list consisting of packet arrival rate, packet processing capacity, packet input queue length, and packet waiting time.

16. The TE entity of claim 11 wherein the processor is further configured to determine one or more routes according to the packet generation rate and the node status and the transmitter is configured to transmit instructions for routing the plurality of packets along the one or more determined routes.

17. A device for transmitting a plurality of packets comprising:
a processor;
an input interface communicatively coupled to the processor, for receiving:
parameters related to a packet generation rate in packets per second for packets arriving at a source node; and
parameters related to node status indicating packet processing capacity of nodes in a network;
a memory communicatively coupled to the processor and having stored thereon machine readable code which when executed by the processor causes the processor to determine routing instructions for routing a plurality of packets between the nodes of a communications network according to the parameters; and
an output interface communicatively coupled to the processor for outputting routing instructions for routing the packets.

18. The device of claim 17 wherein the machine readable code includes machine readable code for performing an optimization calculation based on an objective function and constraints based on the packet generation rate and the node status.

19. The device of claim 18 wherein the machine readable code includes machine readable code for:
determining the packet generation rate in packets per second for packets arriving at a source node from the received parameters; and
the node status of nodes along possible paths from the source node to a destination node from the received parameters.

20. The device of claim 17 wherein the input interface receives directly:
the packet generation rate from a source node for packets directed to a destination node; and
the node status from nodes along possible paths from the source node to the destination node.
